(19) United States
(12) Patent Application Publication
(10) Pub. No.: US 2002/0169882 A1
(43) Pub. Date: Nov. 14, 2002

(54) System and method of creating mass-customized multi-component articles

(76) Inventor: Wole Fayemi, White Plains, NY (US)

Correspondence Address: SHAHAN ISLAM, ESQ., ROSENMAN & COLIN LLP, 575 Madison Avenue, New York, NY, 10022-2585, US

(21) Appl. No.: 09/854,347

(22) Filed: May 11, 2001

(51) Int. Cl. B65C 1/00

(52) U.S. Cl. 709/229; 709/249; 709/250; 156/60; 156/64

(57) ABSTRACT

A method for mass-customizing and assembling multi-component articles includes the steps of choosing the article and selecting the components attachable to the three-dimensional structure of the article, searching a database of constituent components that permits a consumer to choose the desired constituent component (s) compatible with a consumer's previously selected components and combining the attributes of the constituent components to determine performance attributes of multi-component combinations.

### FIELD OF THE INVENTION

The invention relates to the field of manufacturing, and more precisely, to the manner in which multi-component articles can be mass-customized and manufactured. The method disclosed and claimed herein, provides for capturing consumer input to design the multi-component article of choice, maintaining a process to ensure full system compatibility and using information to adjust and coordinate supply chain activity so as to regulate and predict costs and length of waiting period until delivery of the customized multi-component article.

### BACKGROUND OF THE INVENTION

Mass customization may be considered as a process by which typically mass-marketed goods and services are tailored to the personal specifications of each consumer or customer, and provided to that customer at an affordable price. It is a process that combines the desirability of “custom made” goods with the economy of “mass production.” The trend to mass customization is made possible in large part by recent advances in various aspects of digital technology and e-commerce.

In order to make the transition between mass production, (i.e., creating high volumes of more generic products) and mass customization (i.e., making less volume of more customized products) industries needed to wait until the Information Age provided the means to store and transmit large amounts of information inexpensively. Computer-controlled manufacturing makes it faster and cheaper to alter designs, and assemble one-of a-kind items.

Mass-customization can be adapted to serve the needs of distinct markets, ranging in size from a specific customer to a regional market (as opposed to national or international). Accordingly, mass-customization strategies are being applied to a wide variety of products. Some of the industries practicing mass-customization include computers, golf clubs, crop harvesting machinery, small appliances, windows and electronic pagers. There is however, a need for mass-customization of complex multi-component articles.

A multi-component article may be viewed as a system that is composed of functionally compartmentalized yet systematically interdependent sub-systems. Each sub-system may perform functions completely unrelated to the other sub-systems yet in combination, the subsystems comprise a single system with macro functionality. The autonomy and diversity of subsystems is significant to the potential complexity of the mass-customization of multi-component articles because only particular combinations of sub-systems will deliver the suitable or desired system functionality. As the complexity of interdependencies among sub-systems increases, the ability to mass-customize a properly functioning system becomes significantly more difficult.

For example, an automobile is composed of distinct sub-systems, wherein each performs one or more distinct functions. It has an engine that defines the performance of the automobile, a transmission to regulate movement, tires/wheels/break system to allow and control the motion, electronic entertainment and communications systems, enclosed compartments to protect the inner workings of the automobile and accommodate a driver and passengers, a safety system that includes various external and internal lights, performance monitoring systems composed of meters, and a protective body all of which are configured on a structural support or chassis. A customized automobile would use consumer chosen materials for every sub-system. For example, the consumer could select a V8 engine, 6 speed manual transmission, aluminum alloy wheels, 18″ tires, et cetera. The customization process becomes very complex because the value of a customized automobile is partially driven by giving a consumer what he or she wants, but also by ensuring that, once customized, the entire system drives, rides and functions properly. This process is further complicated on a mass scale where time and cost must be controlled and predicted.

The incorporation of distinct functional sub-systems into a multi-component article's design creates complexity due to the scope of different materials and manufacturing expertise needed to create each sub-system. Therefore, a key goal of any mass-customization process is to monitor and coordinate the different suppliers and manufacturers that eventually contribute to the assembly of the final article that is made available to a customer. In the case of a car, for example, the tire manufacturers need to be updated every time a wheel assembly is needed.

It is known that one of the keys to a successful mass-customization scheme is the end-product's modular design. Without a modular design, product customization would be much more time consuming and expensive. However, as stated above, the efficiency of mass-customization schemes will greatly depend on the complexity of the article produced even if the article is of a modular design. At present, industries where mass-customization is in use produce articles where the modular designs are simplified in that the spectrum of the technologies, raw materials and expertise required to produce the final end-product are not particularly broad. Because designs variations are simplified for use in mass-customization, current methods do not have to ensure sophisticated system compatibility and functionality.

One example where mass-customization is used today is in the purchase of a personal computer. The modular electronic components of a computer allow the computer to perform various customized functions desired by the user. For example, the addition of a sound card at the time of purchase or afterwards can expand the audio capabilities to include surround sound instead of the factory-installed mono speaker. While the additional functionality provided by each computer component can be complex, the process of selecting harmonious components and assembling a functioning system is quite simple. Component compatibility is ensured by industry-accepted communication standards and assembly is simplified using standard connections and slots. Vendors who sell customized computers have implemented a process that checks compatibility of parts, but they have not had to implement a process that ensures the new system performance meets the expectations of their consumer once customized because the spectrum of different expertise, engineering principles and standards and raw materials is not likely to be as diverse as, for example, the automobile hypothetical illustrated above. Other mass-customized articles, such as golf clubs, articles of clothing, or small appliances present even more simplified examples of mass-customized articles.

When mass-customizing multi-component articles a second key element to ensure efficient operation of the overall process is information integration. One reason for this need is that the spectrum of different manufacturers and suppliers that comprise a relevant supply chain may be quite large. Integrated information systems provide a relatively cost-efficient way to coordinate all of the members of the multi-component article's supply chain within any given tier and across tier boundaries.

A second reason for the need to integrate information management into the mass-customization scheme efficiently is the prevailing uncertainty inherent in a mass-customization process. The source of the uncertainty is based on the multi-component article manufacturer, referred to as OEM in supply chain parlance, not knowing what it will be assembling and shipping until the precise customized order is submitted. Information management is key to permit the OEM and other role players (i.e., suppliers and manufacturers in the supply chain) to communicate with each other efficiently and continuously, and thus anticipate and update inventories and schedules accordingly.

The foregoing discussion indicates why there is a need for mass-customization methods that are geared toward complex multi-component articles. The inventive method disclosed and claimed herein provides for such a method.

### SUMMARY OF THE INVENTION

The present invention relates to a method for the mass-customization of a multi-component article. The method provides for high levels of consumer input that is virtually nonexistent in mass-customization schemes geared toward complex articles. In addition, the process can be just as easily applied to situations where the customer merely wants to make modifications of his currently owned article, rather than completely create a new one. The method therefore is adaptable for serving users with varying needs and financial resources.

It is an object of the invention to provide for a method to mass-customize complex articles that are modular in design, wherein the modules or components employed in assembling the final multi-component article have been chosen by the customer. The method allows for a customer to choose components and assess the component's desirability on a virtual image. For example, the image may be a computerized image or a holographic recreation of the multi-component article of interest, or even a conventional two dimensional illustration.

It is another object of the invention to provide a computer database that catalogues the multi-component article's components. The data stored therein may include, but is not limited to structural data, color, size and shape data to indicate where on the multi-component article the component may be functionally combined. Such data may be used in constructing the virtual image of the customer's custom design, to show how the components appear. The database may also include data relating to the availability and cost of the component or part, the cost of installing it, projected life span and depreciation in value during that time, etc.

It is still another object of the invention to provide a method of integrating data from the subsystems of a multi-component article to calculate attributes of the combined system. The attributes of the system may include, but are not limited to, weight, size, usability, performance and comfort. Such data may be used to simulate the use of the product or compare the product to others.

It is still another object of this invention to provide a method of assembling a multi-component article, wherein the OEM, and the members or role players of the supply chain communicate with each other within and across supply chain tiers. Thus the OEM, the immediate suppliers that supply the OEM (i.e., Tier 1 suppliers) and those that supply Tier 1 suppliers (i.e., Tier 2 suppliers), and so forth, are all integrated by a computer network. The computer network allows all role players to communicate information that includes but is not limited to, costs of raw materials or components, and the time frames required for the manufacture and delivery of a component to a specific role player, including the OEM. Such data may also be used by members of the supply chain to update and adjusts inventories, based on consumers' demand for particular components.

Another important feature and object of the inventive method, is to provide a method whereby the present owner of a not-new multi-component article may modify or rebuild the article. In this scenario, the customer may use the inventive method to modify one or more components. Alternatively, he or she may virtually rebuild the article by choosing to replace one or more entire sub-systems. If this is the goal, the customer may use the virtual image of the article to “strip” the article of components or sub-systems, and replace them as desired.

A further object of the inventive method is to provide a system and method of creating mass-customized multi-component articles in which as components of the article are selected by a purchaser the universe of compatible components are narrowed to include only further components which are compatible with the components already selected for the article.

The general approach to this method of mass customization will be described for the case of an automobile mass-customization process. However, it should be clear that one with ordinary skill in the art could modify this method to mass-customize various articles without making significant modifications. What is necessary is that the articles are of a modular design that allows easy assembly/disassembly of separate components and/or subsystems.

### BRIEF DESCRIPTION OF THE DRAWING

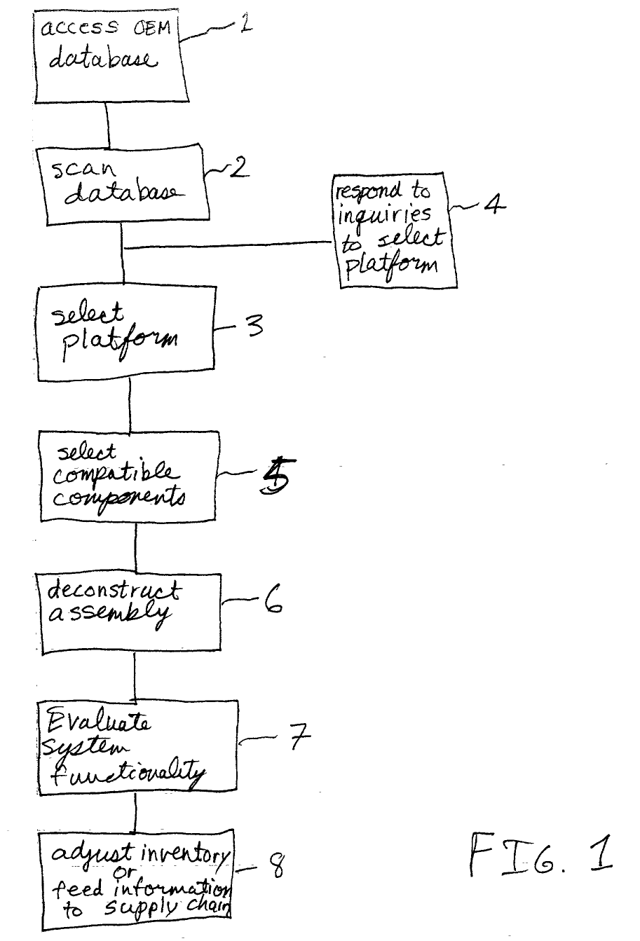

The invention will be better understood by the Detailed Description of the Preferred Embodiment, with reference to the drawing, in which FIG. 1 is a schematic flow chart of the preferred embodiment of the invention.

### DETAILED DESCRIPTION OF THE PREFERRED EMBODIMENT OF THE INVENTION

For the purposes of illustration only, the inventive method will be described with respect to automobiles, because automobile mass-customization represents a good example of a multi-component article or multi-component system that is comprised of a complex aggregate of structurally and functionally compatible interdependent sub-systems. Further, these sub-systems may themselves be composed of modular components, each of which may be replaced with variants of different characteristics. However, it is well understood that the supply, production, manufacture and assembly of other multi-component articles may follow the same or similar methods, without significantly departing from the invention described herein.

According the Figure, a style-conscious consumer may access the OEM (box 1) in person or on the Internet. In either manner, the consumer gains access to a database that warehouses lists and categories of components and sub-systems as well as information that a consumer may consider relevant to his or her ultimate purchase.

The consumer desiring a new automobile may scan the database (box 2) looking for the proper platform from among those that the OEM offers. Choosing a platform, for example a BMW or other prefabricated platform (box 3), will automatically activate the virtual showroom. The platform may be chosen directly by the consumer or, optionally, be chosen for him/her based on responses to inquiries (box 4) such as salary, profession personality trusts etc. Alternatively, the virtual showroom feature may be activated independently.

The virtual showroom will produce 3-D renderings and photographs of the chosen items as they are combined into the consumer's customized automobile. The consumer may begin selecting components (box 5) with the chassis and engine so as to define the generalized nature of the chosen platform and the automobile's performance. In the inventive method, the relevant universe of compatible components are narrowed to include only further components which are compatible with components already selected for the automobile. The compatibility of components may also be determined by external factors such as environmental or other rules and regulations of the purchaser's home area.

Alternatively, and critical to the scope of consumer choice afforded by the method an entire image of a complete automobile may be generated, and the consumer may deconstruct (box 6) the image; essentially dismantle the virtual automobile component by component, subsystem by sub-system, and replace them accordingly.

This deconstructing capability is a key feature in the overall inventive method. It allows an OEM of other high end multi-component articles, not just automobiles and vehicles, to reach design and performance-conscious consumers that possess modest resources. For example, the database may be constructed to include data from several platforms. A customer with an older automobile conforming to such a platform may want to upgrade rather than buy new. Selling the automobile would not be economically efficient, because a new automobile's value could depreciate by 65% after only 2 years. It makes more economic sense to such a consumer to give his older automobile an overhaul. The consumer can obtain greater savings still by purchasing pre-owned parts. In fact, the method herein allows the consumer's entire “new” automobile (or any multi-component article) to be created from recycled components.

The virtual showroom can be used to examine any desired change to any component or sub-system. This includes, but is not limited to modifications of, the body of the car including panels of the hood, fenders, trunk, roof bumpers, the tires and break system, the engine including any performance enhancing or monitoring electronics, entertainment or communication systems, and the various modules of the interior compartment, such as seats, dashboard, meters, glove compartment, etc.

The database stores performance-related information for each component. Such data may include, but is not limited to, a component's shape, and color, physical dimensions, material composition, availability, the age and history of use of the component, year and model of manufacture, and the structural and functional compatibility of a component with the platform and/or other components with which it is to be used.

Once the set of sub-systems has been selected, the combined component data may be used to evaluate system functionality (box 7). In the case of a car, this system functionality may include, but is not limited to a system's curb weight, acceleration, braking, handling and comfort.

When a customer's series of choices are finalized, each datum related to that choice is processed. The OEM database will immediately readjust its inventory (box 8) to reflect the last series of choices made by a customer. The database may signal that the inventory of a specific item has dipped below a pre-determined level, and as a result, provides management with an indicator of a need to re-order.

Alternatively, the database will feed all choice-related information into a computer network, to which all members of the OEM's supply chain have access. Thus, the re-order signal may be sent directly to the OEM's relevant suppliers at all tiers of the supply chain enabling all role players to coordinate among themselves the most efficient means to satisfy the consumer need, as reflected in the changes in inventory of the OEM's database.

Another important function of the computer network is to provide data to all role players of the supply chain so that each member can better predict the market demand for various items and therefore adjust its inventories and/or manufacturing capabilities accordingly.

For example, if consumers are favoring BMWTM platforms, the supply chain will respond by manufacturing or obtaining components that are compatible functionally and structurally with that platform. In principle, this applies to any feature offered in OEM's database. Therefore, consumer data showing both positive and negative preferences can be incorporated into the supply chain members' inventory optimization strategies. Members may respond by adjusting 11088431 02 inventories of components or raw materials required to assemble more complex components or sub-systems. In this manner, the supply chain is poised to efficiently respond to the most current consumer demand or trend.

While the preferred embodiment of the invention has been depicted in detail, modifications and adaptations may be made thereto without departing from the spirit and scope of the invention as delineated in the following claims:

What is claimed is:

1. A method for mass-customizing and assembling multi-component articles for a consumer, said method comprising the steps of:
choosing a multiple component article to be assembled;
selecting constituent components adaptable to said multi-component article, wherein said constituent component is attachable to the three-dimensional structure of said multi-component article;
searching a database wherein said database is in part a catalogue of said constituent components that permits a consumer to choose one or more desired constituent components that are compatible with a consumer's previously selected components; and
combining the attributes of said constituent components to determine performance attributes of multi-component combinations.

2. The method of claim 1 further comprising the steps of:
using the results from said database search to virtually assemble said chosen multi-component article and said chosen constituent component combinations into viewable representation of said multi-component article displaying said one or more chosen constituent components.

3. The method of claim 1 further comprising the steps of:
storing in a computer network, data relating to:
assessing said consumer's satisfaction with one or more of said constituent components or combinations thereof;
transmitting said data to specified role players of said multi-component article's supply chain, so as to coordinate role player activity within and across each tier of said supply chain; and
obtaining said constituent components from role players in an appropriate supply chain; and
manufacturing and assembling said multi-component article;
coordinating the manufacture, shipping and actual delivery of said constituent components to a multi-component article assembling facility.

3. The method of claim 1, wherein the step of choosing the multiple-components article to be assembled is undertaken by the consumer.

4. The method of claim 1, wherein the step of choosing the multiple-components article to be assembled is undertaken as a result of consumer responses to inquiries.

5. The method of claim 1, wherein the step of searching the database compatible components are narrowed to include only further components which as compatible with components already selected.

6. The method of claim 1, wherein said multi-component article is a vehicle.

7. The method of claim 6, wherein said vehicle is selected from the group consisting of automobiles, trucks, boats, ships, and air-borne vehicles.

8. The method of claim 1, wherein said multi-component article is selected from the group consisting of automobiles, trucks, boats, ships, and vehicles capable of air travel.

9. The method of claim 1, wherein said multi-component article is either new or previously owned.

10. The method of claim 5, wherein said constituent component is brand new, or previously owned.

11. The method of claim 2, wherein said virtual representation and said virtual map recreate the structural features of a consumer's presently owned multi-component article; and
said consumer modifies at least one feature of said presently owned multi-component article by choosing from the database one or more constituent components to create said virtual image, so as to assess the desirability of said modification.

12. The method of claim 1, wherein said database stores data comprising:
a variety of multi-component article customization and production features that define the appearance, structural nature, performance, manufacturing and consumer costs, of any of said constituent components; and further, wherein said data includes features of said constituent components that may be relevant to said consumer such as,
physical compatibility and operability when combined with a particular multi-component article;
physical compatibility and operability when combined with other constituent components;
physical compatibility and operability under specified conditions of use;
specific year and model of the multi-component article;
physical durability of said constituent component;
projected depreciated value of the individual constituent components after varying periods of use;
projected depreciated value of the multi-component article as a whole;
choices of materials, colors, styling modifications, maintenance and repair services, environmental hazard indices, and cost and price information.

13. The method claim 1, wherein the multi-component article is a system comprised of subsystems.

14. The method of claim 12, wherein the multi-component system is an automobile, and said sub-systems include but are not limited to, an engine, a chassis, a steering sub-system, a braking sub-system and an electronic entertainment/communication/tracking sub-system.

15. The method of claim 14, wherein a sub-system may be replaced in its entirety, or in part by replacing one or more of the sub-system's constituent components.

16. The method of claim 1, wherein the said performance attributes include weight.

17. The method of claim 1, wherein the said performance attributes include acceleration.

18. The method of claim 1, wherein the said performance attributes include braking.

19. The method of claim 1, wherein the said performance attributes include handling.

20. A method for mass-customizing and assembling automobiles, said method comprising the steps of:
selecting constituent components adaptable to said automobile;
searching a database wherein said database is in part a catalog of said constituent components that permits a consumer to choose one or more desired constituent conponents that are compatible with a consumer's previously selected components; and
combining the attribute of said constituent components to determine performance attributes of multi-component combinations.

21. The method of claim 20, further comprising the step of:
storing in a computer network, data relating to:
assessment of said consumer's satisfaction with one or more of said constituent components or combinations thereof;
obtaining said constituent components from role players in an automobile manufacturing supply chain;
manufacturing and assembling said automobile;
transmitting said data to specified role players of said supply chain, so as to coordinate role player activity within and across each tier of said supply chain; and
coordinating the manufacture, shipping and actual delivery of said constituent components to an automobile assembling facility.

22. The method of claim 21, wherein said database stores data comprising:
choices of automobile customization and production features;
wherein said data relates to appearance, structural nature, performance or cost of any of said features; and
wherein said data defines said automobile features such as,
platform, manufacturing panel technology, choice of powertrain, year of the car, projected depreciated value of the individual parts, projected depreciated value of the car as a whole, choice of interior materials, choice of colors, choice of styling modifications, choice of electronic equipment and services, emission values, electronic footprint of engine/exhaust note, intended, and cost and price information.

23. The method of claim 21, wherein the database further comprises a means to determine the present market demand for said automobile, said demand being determined by comparing said data with a current supply/demand curves for automobiles having characteristics similar to said automobile.

24. The method of claim 21, wherein the computer network transmits said consumer choice data to all role players at all tiers of the supply chain permitting all role players to monitor and update, their supply-related activities and their demand-related activities, and to transmit said updated information to all other role players at all tiers of said supply chain.

25. The method of claim 21, wherein all supply chain participants use database management software that recursively and continuously tracks consumer preferences and trends, and adjusts its inventories, availability, and costs of constituent components, and length of delays in shipping and final delivery times to another participant of said supply chain.

26. The method of claim 21, wherein each role player maximizes its demand-related activities by tracking consumer choices, and adjusting inventories accordingly.

27. The method of claim 21, wherein said automobile components may perform at least one function relating to the aesthetic, structural or performance nature of said customized automobile.

28. The method of claim 21, wherein said component database stores and recursively analyzes information relating to the appearance and/or the performance of said constituent components, the costs of purchasing and installing said components, and the availability of said constituent components so as to provide updated delivery dates of an assembled or modified automobile to a consumer.

29. The method of claim 21, wherein said computer network further performs the additional steps of:
receiving said consumer's personal financial information and comparing said financial information with costs of producing and assembling said automobile; and
creating a personalized financing scheme to permit said consumer to purchase modifications of an automobile, or said customized automobile.
